(19) United States
(12) Patent Application Publication
(10) Pub. No.: US 2012/0229841 A1
(43) Pub. Date: Sep. 13, 2012

(54) DIRECT INTERFACE BETWEEN PRINTING DEVICE AND PERIPHERAL DEVICE

(75) Inventors: Donald M. Pangrazio, III, LeRoy, NY (US); Damian Kumor, Webster, NY (US)

(73) Assignee: XEROX CORPORATION, Norwalk, CT (US)

(21) Appl. No.: 13/041,479

(22) Filed: Mar. 7, 2011

(51) Int. Cl. G06F 3/12

(52) U.S. Cl. 358/1.15

(57) ABSTRACT

A method and device connect a peripheral interface of a printing machine to an external peripheral device. The external peripheral device is a separate device from the printing machine. At least one external peripheral device menu is provided through a user interface of the printing machine and inputs are received to the external peripheral device menu. A processor of the printing machine controls operations of the external peripheral device based on the inputs to the external peripheral device menu. The processor executes instructions when providing the external peripheral device menu and when controlling operations of the external peripheral device.

### BACKGROUND

Embodiments herein generally relate to printing devices and peripherals to printing devices and more particularly to a method and printing device that can directly interface with specialty peripheral devices without requiring an intermediate computer.

Standard printing devices do not support scanning of X-Rays, film, and are not especially adaptive to scan receipts, business cards, or photos. However, there are many specialty peripheral devices that support scanning of X-Rays, film, receipts, business cards, or photos, and such devices would see benefits of leveraging the vast array of functions available on modern multi-function printing devices. Such functions include security features, network access, accounting, certifications (whether corporate or industry standards), printing, copy, fax, etc.

### SUMMARY

An exemplary method herein controls an external peripheral device (such as an external scanner, external reader, external camera, external image processor, etc.) using a printing machine. The printing machine comprises at least one marking engine. The marking engine is operatively connected to at least one processor. The printing machine can also include at least one peripheral interface that is operatively connected to the processor, and at least one integral scanner that is operatively connected to the processor. At least one user interface is also operatively connected to the processor.

The method connects the peripheral interface to an external peripheral device. The peripheral interface to external peripheral device connection can be a wired or wireless connection. The external peripheral device is a separate device from the printing machine. The method provides at least one external peripheral device menu through the user interface and receives inputs to the external peripheral device menu. The processor controls operations of the external peripheral device based on the inputs to the external peripheral device menu. The method executes instructions, using the processor, when providing the external peripheral device menu and when controlling operations of the external peripheral device. Such instructions are stored on an external peripheral storage device that is integral with the external peripheral device.

The method can also provide at least one integral scanner menu through the user interface. The integral scanner menu provides different menu options from the external peripheral device menu. The method also receives inputs to the integral scanner menu and controls operations of the integral scanner based on the inputs to the integral scanner menu using the processor.

The method can also provide, to the external peripheral device, access to and from an external network through a network connection. The network connection is also integral with the printing machine and is operatively connected to the processor and to the external network.

The method can also maintain accounting information relating to usage of the external peripheral device in at least one computer-readable storage device that is integral with the printing machine and is operatively connected to the processor.

An exemplary printing machine according to embodiments herein comprises at least one processor that is integral with the printing machine. At least one computer-readable storage device that is integral with the printing machine is operatively connected to the processor. At least one marking engine that is integral with the printing machine is also operatively connected to the processor. Further, at least one integral scanner that is integral with the printing machine is operatively connected to the processor.

Additionally, at least one peripheral interface that is integral with the printing machine is operatively connected to the processor and to an external peripheral device (such as an external scanner, external reader, external camera, external image processor, etc.). The external peripheral device is a separate device from the printing machine. At least one user interface that is integral with the printing machine is operatively connected to the processor. The user interface provides at least one external peripheral device menu. Inputs to the external peripheral device menu control operations of the external peripheral device. The processor executes instructions stored on a scanner storage device that is integral with the external peripheral device when providing the external peripheral device menu and when controlling operations of the external peripheral device. The user interface can also provide at least one integral scanner menu. Inputs to the integral scanner menu control operations of the integral scanner. The external peripheral device menu provides different menu options than does the integral scanner menu.

The printing machine also includes a network connection that is integral with the printing machine and is operatively connected to the processor and to an external network. The processor provides access to and from the external network to the external peripheral device through the network connection. The processor can maintain accounting information relating to usage of the external peripheral device in the computer-readable storage device. The peripheral interface can include a wired and/or wireless connection.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic flow diagram illustrating operations of embodiments herein;

FIG. 2 is a schematic flow diagram illustrating operations of embodiments herein;

FIG. 3 is a schematic flow diagram illustrating operations of embodiments herein;

FIG. 4 is a schematic flow diagram illustrating operations of embodiments herein;

FIG. 5 is a schematic flow diagram illustrating operations of embodiments herein;

FIG. 6 is a schematic flow diagram illustrating operations of embodiments herein; and

FIG. 7 is a schematic diagram of device embodiments herein.

### DETAILED DESCRIPTION

Many conventional printing devices are placed in environments where specialty scanning is a requirement, such as in medical claims processing in the health market segment. However, in order to utilize specialty peripherals, conventional printing devices need to communicate with such peripherals through a separate computer, such as a personal computer that is connected to both the printing device and the specialty peripheral device. The embodiments described herein enable conventional printing machines to directly integrate specialty scanners without the need for an intermediate computing device.

Current multi-function printing devices provide network connectivity and accounting features that allow such printing devices to be used as stand alone point of sale (POS) or kiosk devices. However, smaller specialty scanners cannot participate in such scenarios without additional intermediate computers, which increases the cost and complexity of such standalone POS or kiosk devices that desire to provide the functionality associated with the specialty peripheral device. The embodiments provide a direct interface between specialty peripherals and multifunction printing devices and thereby open the door for these specialty scanners to directly connect to sophisticated multi-function printing devices that operate as kiosk or POS devices, without the expense or complexity associated with intermediate computers.

Further, some organizations have certification processes used to accept a particular printing device at a particular software release level. Others use national standard certifications. Designing and manufacturing a specialty peripheral device that complies with such certification standards can dramatically increase the cost and complexity of the peripheral device and, therefore, such specialty peripheral devices often do not comply with such certification standards (or at least are not put through the certification process). The lack of such certifications sometimes limits the use of specialty scanners; however, if such peripheral devices are integrated with a certified printing device platform (using the embodiments herein) the specialty scanners can be considered properly certified through the printing device's certification.

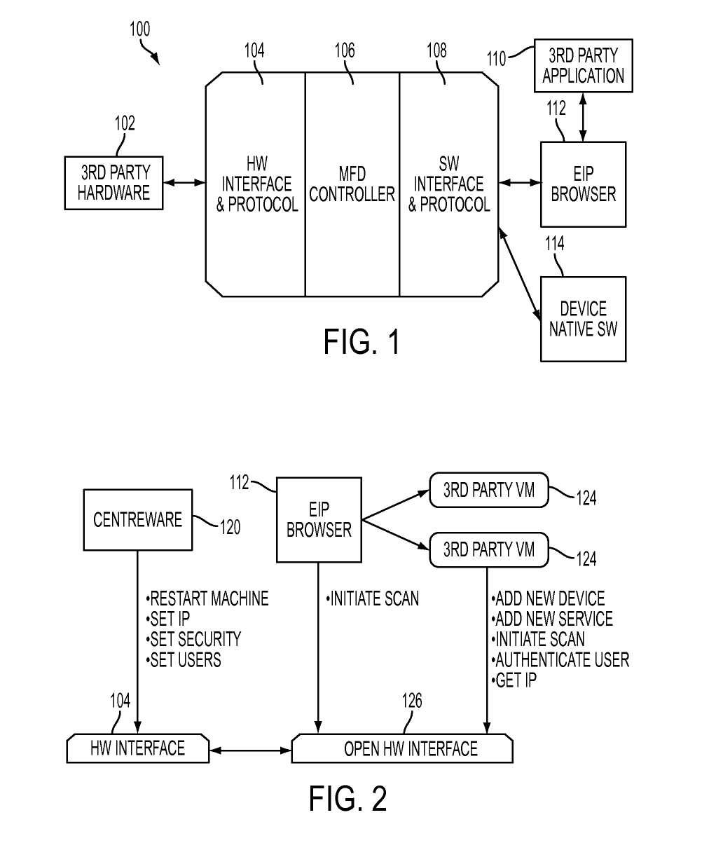

In one mode shown in FIG. 1, embodiments herein provide a standard interface and protocol for devices to follow that ensures they are accessible to the printing device's applications. FIG. 1 illustrates a peripheral item 102 (3^{rd} party hardware) such as an external scanner, external reader, external camera, external image processor, etc. The peripheral item 102 uses proprietary software instructions 110 (3^{rd} party application) to perform its specialty operations. As shown in FIG. 1, the 3^{rd} party hardware 102 can operatively connect to a printing device 100 through a hardware interface 104 (using appropriate hardware protocols) and the 3^{rd} party application 110 can be accessed through the software interface 108 of the printing device 100. As is understood by those ordinarily skilled in the art, when one item is referred to as being “operatively connected to” another item, this connection can be direct or indirect, and can be a wired connection or a wireless connection.

The printing device 100 also includes a controller 106 operatively connected to the hardware interface 104 as well as a software interface 108 (and associated protocols). The software interface 108 connects to an application programming interface (API) (such as an extended interface platform (EIP) browser) 112 as well as the devices native software 114. In this example, the 3^{rd} party application 110 connects through the browser 112. As is understood by those ordinarily skilled in the art, an application programming interface is a software interface to which software designers have been provided instructions that allow the software designers to freely connect and utilize the features of the device that has application programming interface. While the application programming interface allows access to various components of the printing device 100 (and can even allow for portions of the computer memory and computer processing to be dedicated to a virtual machine for the specialty peripheral device) the application programming interface has strict security features which prevent 3^{rd} party applications from inappropriate use of such printing device components.

For example, software designers would be provided instructions of how they could design their 3^{rd} party application 110 to communicate with the printing device 100 through the application programming interface (in this case through the EPI browser 112) to utilize the various features of the printing device 100 (such as the processor, graphic user interface, network connections, etc.) automatically when the 3^{rd} party specialty peripheral device 102 is operatively connected to the printing device 100. As used herein, the term “automatically” means that the machines perform all necessary operations without additional user interaction (after, for example, the user has connected the specialty peripheral device to the printing device; however, this step could also be automated).

Therefore, by following the publicly provided instructions corresponding to the application programming interface, the software designers of the 3^{rd} party application could create a specialty peripheral device and 3^{rd} party application that are seamlessly controlled through the graphic user interface of the printing device once the user connects (wirelessly or in a wired manner) the specialty peripheral device to the printing device. Because the process is automatic, the user merely needs to connect the specialty peripheral device to the printing device and then control the specialty peripheral device through the printing device, without having to take any additional actions, such as loading drivers, defining communication ports or methodologies, etc. Such drivers, etc., can be loaded to the printer from the computer storage of the peripheral, or could be downloaded automatically by the printer from a network, such as Internet.

The operational mode shown in FIG. 1 simplifies the extension of the printing device 100 features for 3^{rd} parties that create hardware and software. The embodiments herein enable 3^{rd} party hardware vendors to create hardware that the controller 106 can use. Protocols for communication between the 3rd party hardware 102 and the printing device 100 are defined for 3^{rd} parties to utilize when creating 3^{rd} party applications 110. For example, one basic protocol for scanning is provided where the printing device 100 will tell the 3^{rd} party devices 102 to use the well-known TWAIN protocol. TWAIN is a standard software protocol and application programming interface (API) that regulates communication between software applications and imaging devices such as scanners and digital cameras that is maintained by the not-for-profit organization TWAIN Working Group, and is available at twain.org.

From the software interface side 108 of this mode, the browser 112 accesses the data returned from the 3rd party hardware 102 so that 3rd party application 110 can access the data. The data can also be provided to the printing machine's 100 native functions like printing, faxing, and network communications for further processing to allow the specialty peripheral device 102 to utilize all the features of the potentially certified and more sophisticated printing device 100.

FIG. 2 illustrates another mode, where 3^{rd} party products are added to the features of the printing device 100 by encasing them into virtual machines (VM) 124 operating through the controller/processor 106 and connected to the browser 112. These virtual machines 124 are able to retrieve a separate internet protocol (IP) address or are able to share the IP address of the printing device 100 depending on the configuration.

Each VM 124 has access to the printing device 100 through a special open hardware interface 126. This interface 126 provides functions to register the VM 124 with certain hardware components, initiate scanning, etc. FIG. 2 shows that the open hardware interface 126 allows 3^{rd} party applications 124 (operating on the virtual machines 124) to issue commands, receive data, add new devices, add new services, initiate scans, authenticate users, get IP addresses, etc.

Further, FIG. 2 illustrates a feature referred to as “CentreWare” 120 that connects to the hardware interface 104 and allows the hardware interface 104 to restart the peripheral, set the IP address for the peripheral, and provide security settings and user settings. CentreWare Internet Services is an interactive service that uses Internet technology to extend the capabilities of the printer using Internet technology. An HTTP server application is resident on your network-enabled printers. This HTTP server provides access to advanced services for the installation, configuration, and management of the printer.

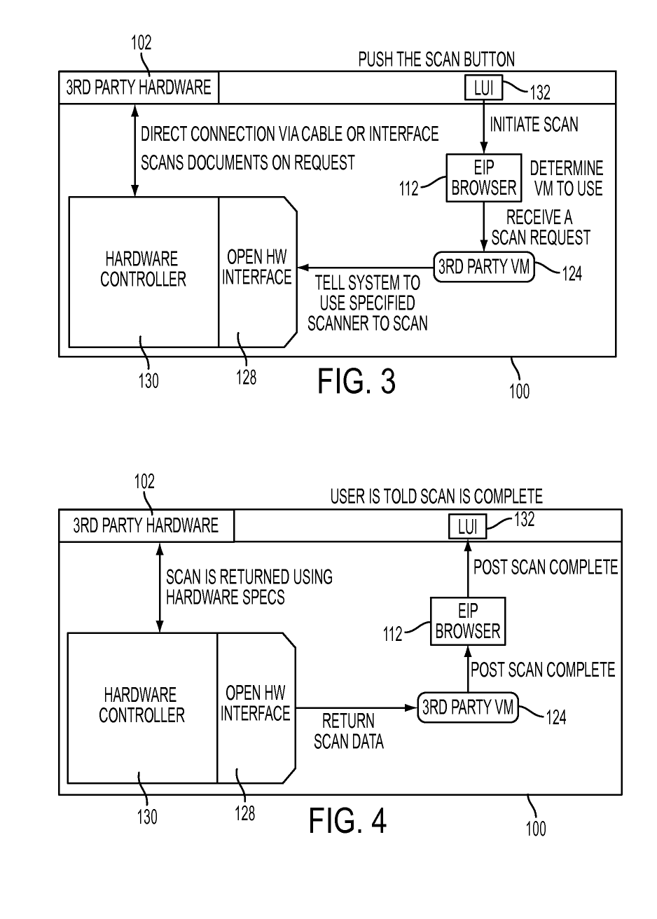

An example flow in FIG. 3 illustrates an operation where a local user interface (LUI) 132 of the printing device 100 presents the user with the option to initiate a scan with a 3^{rd} party scanner 102. The user at the local user interface 132 pushes the scan button. This tells the browser 112 to start the scan, which determines which virtual machine to use, and opens a connection to the 3^{rd} party VM 124. This connection is through a defined interface provided according to the extended interface platform requirements. The 3^{rd} party VM 124 then initiates the scan through the open hardware interface 128 where the virtual machine informs the controller 130 (through the open hardware interface 128) which scanner should be utilized. The controller 130 then causes the specialty peripheral 102 to perform a scan of items (for example documents). At this point the connection between the 3^{rd} party VM 124 and the 3^{rd} party hardware 102 will remain open until data is returned from the scanning process performed by the scanner 102.

As illustrated in FIG. 4 when the scan is complete, the data is returned to the hardware controller 130 using hardware specifications. The hardware controller 130 returns the scan data to the 3^{rd} party VM 124. If desired, the data can be processed to apply adjustments or generate more useful data. The 3^{rd} party VM 124 can then provide a notification to the EIP browser 112 that the scan is complete, and a corresponding message can be provided on the user interface 132.

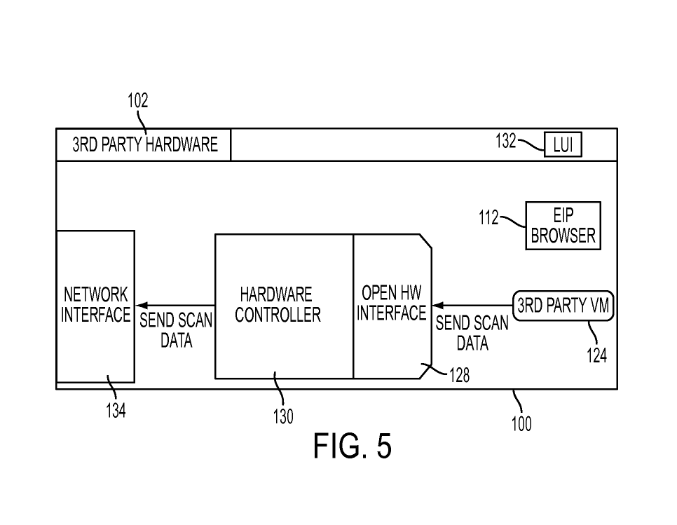

While the data is being provided to the 3^{rd} party VM 124, the VM 124 can process the data returned and make commands to the printing device's elements to execute operations using such data (to print, to fax, to send over networks, etc.). For example, some printing devices may have very limited storage space and utility in keeping scanned files, which may make it preferable to transmit such scans to other devices (such as storage servers). With embodiments herein, the printing devices can use a network interface in conjunction with the VM 124 to transmit the scan in any manner desired. Thus, as illustrated in FIG. 5, the 3^{rd} party VM 124 provides the scanned data to the hardware controller 130 through the open hardware interface 128 that, in turn, provides the scanned data to a network interface 134 that forwards the scan data to an appropriate device connected to the external network, such as a storage server.

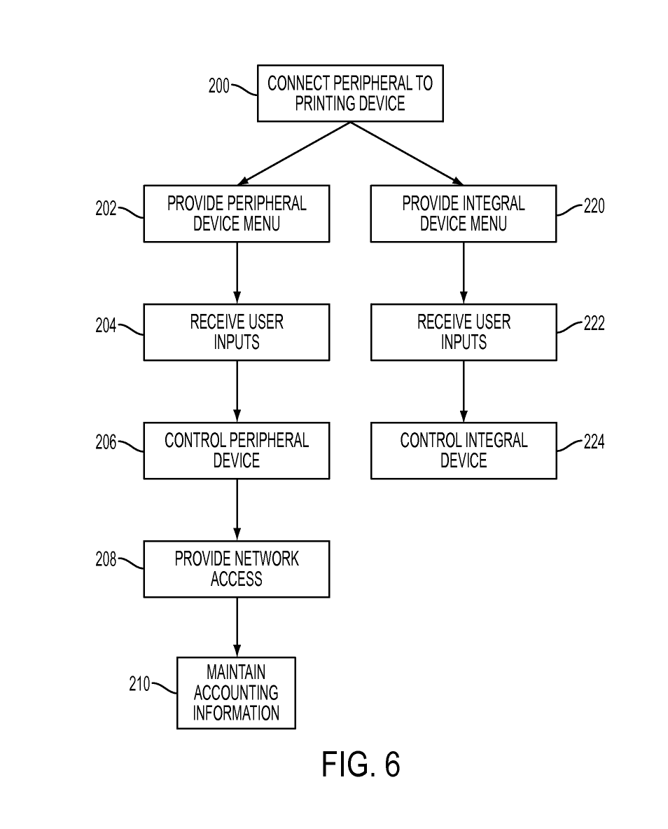

FIG. 6 is a flowchart illustrating one of many exemplary methods herein. Such a method controls an external peripheral device (such as an external scanner, external reader, external camera, external image processor, etc.) using a printing machine. The printing machine comprises at least one marking engine. The marking engine is operatively connected to at least one processor. The printing machine can also include at least one peripheral interface that is operatively connected to the processor, and at least one integral scanner that is operatively connected to (meaning directly or indirectly connected to) the processor. At least one user interface is also operatively connected to the processor.

As shown in item 200, the method connects the peripheral interface to an external peripheral device. The peripheral interface to external peripheral device connection can be a wired or wireless connection. The external peripheral device is a separate device from the printing machine. In item 202, the method provides at least one external peripheral device menu through the user interface of the printer and receives inputs to the external peripheral device menu in item 204. The processor controls operations of the external peripheral device based on the inputs to the external peripheral device menu in item 206. Then, the method executes instructions, using the processor, when providing the external peripheral device menu and when controlling operations of the external peripheral device. Such instructions can be stored on an external peripheral storage device that is integral with the external peripheral device or can be loaded (or network downloaded) onto the computer memory of the printing device.

The method can also provide, to the external peripheral device, access to and from an external network through a network connection in item 208. The network connection is also integral with the printing machine and is operatively connected to the processor and to the external network. The method can also maintain accounting information relating to usage of the external peripheral device in at least one computer-readable storage device that is integral with the printing machine and is operatively connected to the processor as shown in item 210.

The method can also provide at least one integral scanner menu through the user interface in item 220. The integral scanner menu provides different menu options than the external peripheral device menu. The method also receives inputs to the integral scanner menu in item 222 and controls operations of the integral scanner based on the inputs to the integral scanner menu using the processor in item 224.

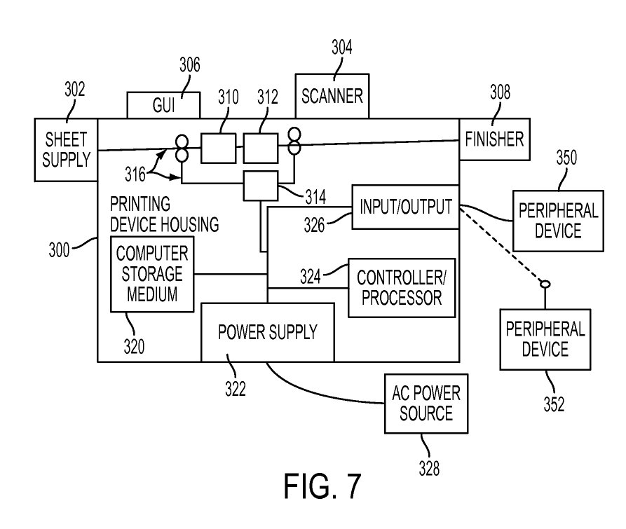

FIG. 7 illustrates a computerized printing device 300, which can be used with embodiments herein and can comprise, for example, a printer, copier, multi-function machine, etc. The printing device 300 includes a controller/processor 324, at least one marking device (printing engines) 310, 312, 314 operatively connected to the processor 324, a media path 316 positioned to supply sheets of media from a sheet supply 302 to the marking device(s) 310, 312, 314, and a communications port (input/output) 326 operatively connected to the processor 324 and to a computerized network external to the printing device. After receiving various markings from the printing engine(s), the sheets of media can optionally pass to a finisher 308 which can fold, staple, sort, etc., the various printed sheets.

Also, the printing device 300 can include at least one accessory functional component (such as a scanner/document handler 304, sheet supply 302, finisher 308, etc.) and graphic user interface assembly 306 that also operate on the power supplied from the external power source 328 (through the power supply 322).

The input/output device 326 is used for communications to and from the multi-function printing device 300. The processor 324 controls the various actions of the printing device. A non-transitory computer storage medium device 320 (which can be optical, magnetic, capacitor based, etc.) is readable by the processor 324 and stores instructions that the processor 324 executes to allow the multi-function printing device to perform its various functions, such as those described herein.

Thus, a printer body housing 300 has one or more functional components that operate on power supplied from the alternating current (AC) 328 by the power supply 322. The power supply 322 connects to an external alternating current power source 328 and converts the external power into the type of power needed by the various components.

As would be understood by those ordinarily skilled in the art, the printing device 300 shown in FIG. 7 is only one example and the embodiments herein are equally applicable to other types of printing devices that may include fewer components or more components. For example, while a limited number of printing engines and paper paths are illustrated in FIG. 7, those ordinarily skilled in the art would understand that many more paper paths and additional printing engines could be included within any printing device used with embodiments herein.

The processor 324, computer-readable storage device 320, marking engine(s) 310, 312, 314, integral scanner 304, user interface 306, sheet supply 302, peripheral interface 326, finisher 308, and power supply 322 are all “integral” with the printing machine 300 (as are many other items not discussed herein or illustrated). Integral means that an item is a permanent part of the printing machine 300 and is permanently attached to the interior or exterior of the printing machine. An integral item is intended to permanently remain with the printing machine and would be removed only when being replaced or repaired (because the integral item is broken, consumed, or worn out).

To the contrary, an item that is external or peripheral to the printing machine 300 is maintained outside the cover of the printing machine 300. Further, an external item may be temporarily connected to the printing machine 300 and is easily connected and disconnected from the printing machine 300. Commonly, the only physical connection between the external item and the printing machine 300 is through plug-type, wired, wireless, etc., connections. Thus, if the printing machine 300 is moved, the external device would not move with the printing machine 300 (except as pulled by the wire-type connection). To the contrary, integral items are generally held firmly to the frame or cover of the printing machine using bolts, screws, rivets, welds, solders, bonding agents, clips, etc., have permanent electrical and physical connections to other elements, and move with the printing machine 300 as it is moved.

The peripheral interface 326 is operatively connected to the processor 324 and to one or more wired (solid line) or wireless (dashed line) external peripheral device(s) 350, 352 (such as an external scanner, external reader, external camera, external image processor, etc.). The external peripheral device(s) 350, 352 are physically separate devices from the printing machine 300. The user interface 306 provides at least one external peripheral device menu. Inputs to the external peripheral device menu control operations of the external peripheral device(s) 350, 352.

Each of the peripheral devices can maintain their own processor(s) and computer storage device(s) (that are integral with the external peripheral device(s) 350, 352). The processor 324 within the printing device 300 executes computer instructions (e.g., software applications) stored on such a scanner storage device when providing the external peripheral device menu and when controlling operations of the external peripheral device. As mentioned above, one or more portions of the printing machine's processor 324 and memory 320 can be exclusively dedicated to running and storing the peripheral device's software to create a virtual machine for the peripheral device within the printing machine 300. In so doing, the method and device embodiments herein provide a seamless integration of the external peripheral device(s) 350, 352 and the printing device 300 for the user.

With embodiments herein, the user connects (wired or wirelessly) the peripheral device(s) 350, 352 to the printing device 300 and, as a result of this action, is automatically presented with the external peripheral device menu on the graphic user interface 306 of the printing device 300. The user provides inputs (menu selections, for example) to the external peripheral device menu on the graphic user interface 306 of the printing device 300 to control actions of the peripheral device(s) 350, 352. Further, through other menu selections on the graphic user interface 306 of the printing device 300, the user can use data obtained by the peripheral device(s) 350, 352 when utilizing other integral features of the printing device 300 (fax features, printing features, network features, etc.).

As with conventional multi-function printing devices, the user interface 306 can also provide at least one integral scanner menu relating to operations of the integral scanner 304. Inputs to the integral scanner menu control operations of the integral scanner 304. The external peripheral device menu provides different menu options than does the integral scanner menu because the peripheral device(s) 350, 352 provide different functionality from the integral scanner 304.

The processor 324 provides access to and from various external networks to the external peripheral device(s) 350, 352 through a network connection of the input/output 326. The processor 324 can maintain accounting information relating to usage of the external peripheral device(s) 350, 352 in the computer-readable storage device 320.

The embodiments herein also provide a framework and protocol that allows for several different types of devices to be interfaced concurrently, limited only by the number of actual or virtual connection ports of the printing device (e.g., USB, Firewire, SCSI, serial, etc.). Power for each peripheral device can either be supplied through an internal source (batteries, etc.), an external power adapter, a specified power interface, etc. Some connectors like universal serial bus (USB) and Firewire allow for enough power to be sent to power small devices and any such power sources (and other power source is not listed herein) can also be used by embodiments herein.

By allowing 3^{rd} party hardware to interface with printing devices, new functionality can be added to the printing machine. Thus, manufacturers of printing devices can leverage the specialty 3^{rd} party applications for processing captured images by allocating resources to virtual machines to run such applications. This functionality uses special software to handle the data returned from the 3rd party hardware. The data returned from the hardware is directly passed to the virtual machines so that it can be processed in the special manner required by the peripheral.

Thus, the embodiments herein provide the ability to support (interface to and select) external peripherals connected as USB, SCSI, Fire wire, etc.; the ability for the printing devices to share IP addresses with any web application that the third party scanner device may support and host on-board; the ability for the printing devices to provide a Virtual Machine (VM) for any special application (such as an EIP Application, web configuration application, or image processing application) on the printing devices base hardware; the ability to authenticate to, account for, bill for scanning service provided by the external specialty scanner, etc.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements).

It is appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A printing machine comprising:
at least one processor integral with said printing machine;
at least one marking engine integral with said printing machine and operatively connected to said processor;
at least one peripheral interface integral with said printing machine and operatively connected to said processor and to an external peripheral device, said external peripheral device being a separate device from said printing machine; and
at least one user interface integral with said printing machine and operatively connected to said processor,
said user interface providing at least one external peripheral device menu, inputs to said external peripheral device menu controlling operations of said external peripheral device.

2. The printing machine according to claim 1, said processor executing instructions stored on a peripheral storage device integral with said external peripheral device when providing said external peripheral device menu and when controlling operations of said external peripheral device.

3. The printing machine according to claim 1, further comprising a network connection integral with said printing machine and operatively connected to said processor and to an external network, said processor providing access to and from said external network to said external peripheral device through said network connection.

4. The printing machine according to claim 1, said processor maintaining accounting information relating to usage of said external peripheral device in at least one computer-readable storage device integral with said printing machine and operatively connected to said processor.

5. The printing machine according to claim 1, said peripheral interface comprising one of a wired and a wireless connection.

6. A printing machine comprising:
at least one processor integral with said printing machine;
at least one computer-readable storage device integral with said printing machine and operatively connected to said processor;
at least one marking engine integral with said printing machine and operatively connected to said processor;
at least one integral scanner integral with said printing machine and operatively connected to said processor;
at least one peripheral interface integral with said printing machine and operatively connected to said processor and to an external scanner, said external scanner being a separate device from said printing machine; and
at least one user interface integral with said printing machine and operatively connected to said processor,
said user interface providing at least one external scanner menu, inputs to said external scanner menu controlling operations of said external scanner,
said user interface providing at least one integral scanner menu, inputs to said integral scanner menu controlling operations of said integral scanner, and
said external scanner menu providing different menu options than said integral scanner menu.

7. The printing machine according to claim 6, said processor executing instructions stored on a scanner storage device integral with said external scanner when providing said external scanner menu and when controlling operations of said external scanner.

8. The printing machine according to claim 6, further comprising a network connection integral with said printing machine and operatively connected to said processor and to an external network, said processor providing access to and from said external network to said external scanner through said network connection.

9. The printing machine according to claim 6, said processor maintaining accounting information relating to usage of said external peripheral device in said computer-readable storage device.

10. The printing machine according to claim 6, said peripheral interface comprising one of a wired and a wireless connection.

11. A method of controlling an external peripheral device using a printing machine, said printing machine comprising at least one marking engine integral with said printing machine and operatively connected to at least one processor integral with said printing machine, at least one peripheral interface integral with said printing machine and operatively connected to said processor, and at least one user interface integral with said printing machine and operatively connected to said processor, said method comprising:
connecting said peripheral interface to an external peripheral device, said external peripheral device being a separate device from said printing machine;
providing at least one external peripheral device menu through said user interface;
receiving inputs to said external peripheral device menu; and
controlling operations of said external peripheral device based on said inputs to said external peripheral device menu using said processor.

12. The method according to claim 11, said method further comprising executing instructions, using said processor, when providing said external peripheral device menu and when controlling operations of said external peripheral device, said instructions being stored on a peripheral storage device within said external peripheral device.

13. The method according to claim 11, further comprising providing, to said external peripheral device, access to and from an external network through a network connection, said network connection being integral with said printing machine and operatively connected to said processor and to said external network.

14. The method according to claim 11, said method further comprising maintaining accounting information relating to usage of said external peripheral device in at least one computer-readable storage device integral with said printing machine and operatively connected to said processor.

15. The method according to claim 11, said peripheral interface comprising one of a wired and a wireless connection.

16. A method of controlling an external scanner using a printing machine, said printing machine comprising at least one marking engine integral with said printing machine and operatively connected to at least one processor integral with said printing machine, at least one peripheral interface integral with said printing machine and operatively connected to said processor, at least one integral scanner integral with said printing machine and operatively connected to said processor, and at least one user interface integral with said printing machine and operatively connected to said processor, said method comprising:
connecting said peripheral interface to an external scanner, said external scanner being a separate device from said printing machine;
providing at least one external scanner menu through said user interface;
receiving inputs to said external scanner menu;
controlling operations of said external scanner based on said inputs to said external scanner menu using said processor;
providing at least one integral scanner menu through said user interface, said integral scanner menu providing different menu options than said external scanner menu;
receiving inputs to said integral scanner menu; and
controlling operations of said integral scanner based on said inputs to said integral scanner menu using said processor.

17. The method according to claim 16, said method further comprising executing instructions, using said processor, when providing said external scanner menu and when controlling operations of said external scanner, said instructions being stored on a scanner storage device integral with said external scanner.

18. The method according to claim 16, further comprising providing, to said external scanner, access to and from an external network through a network connection, said network connection being integral with said printing machine and operatively connected to said processor and to said external network.

19. The method according to claim 16, said method further comprising maintaining accounting information relating to usage of said external scanner in at least one computer-readable storage device integral with said printing machine and operatively connected to said processor.

20. The method according to claim 16, said scanner interface comprising one of a wired and a wireless connection.
